(19) United States
(12) Patent Application Publication
(10) Pub. No.: US 2003/0061026 A1
(43) Pub. Date: Mar. 27, 2003

(54) Method and apparatus for translating one species of a generic language into another species of a generic language

(76) Inventors: Stuart A. Umpleby, Washington, DC (US); John A. Buck, Columbia, MD (US); Dent B. Eric, Rockville, MD (US)

Correspondence Address: WENDEROTH, LIND & PONACK, L.L.P., 2033 K STREET N. W., SUITE 800, WASHINGTON, DC, 20006-1021, US

(21) Appl. No.: 10/231,142

(22) Filed: Aug. 30, 2002

Related U.S. Application Data
(60) Provisional application No. 60/315,747, filed on Aug. 30, 2001.

(51) Int. Cl. G06F 17/20

(52) U.S. Cl. 704/8

(57) ABSTRACT

A method and apparatus for translating includes translating data of one species of a generic language into data of another species of the same generic language. Furthermore the method and apparatus may translate data of a species of a first generic language into data of a species of a second generic language.

This application claims priority under 35 U.S.C. § 119(e) from Provisional U.S. Application No. 60/315,747, filed Aug. 30, 2001, the entire disclosure of which is incorporated herein by reference.

### SUMMARY OF THE INVENTION

The present invention comprises a method and apparatus for translating data from one species of a generic language to a second species of the generic language in order to increase the comprehensibility of the data to a particular audience.

### BACKGROUND OF THE INVENTION

Presently, electronic hardware and software have been used to translate one language to another language, for example, English to French. These types of prior art translation systems, however, do not address the level of reading comprehension of a particular audience. Other prior art electronic hardware and software have been used to rate the readability of a particular portion of text. The prior art readability systems count the number of letters in a word or number of words in a sentence to generate a readability factor. However, such a readability factor does not accurately reflect the readability for a particular text from the perspective of a particular audience.

Within some languages, for example English, there exist many sub-languages. More particularly, English may be considered a generic language comprising at least two species of languages therein. Although a person may be fluent in English, generically, that person may be more adept at comprehending one species of English over another species of English. The prior art translation systems do not address this issue.

As such, there remains a need for a method and apparatus that provides a translation of one species of a generic language into another species of the generic language in order to increase the readability of a body of text for a particular audience.

### BRIEF DESCRIPTION OF THE INVENTION

It is an object of the present invention to provide a method and apparatus for translating one species of a generic language into another species of the generic language.

It is another object of the present invention to provide a method and apparatus for translating one species of one generic language into a species of another generic language.

The present invention is based on the idea that there are “languages within languages,” or species of languages within a generic language. Of these species, some are more technical or more international than others. Those seeking to communicate effectively with a particular audience should use primarily words from the appropriate species that the audience more readily comprehends. The present invention provides translation from one species of a generic language to another species of the generic language for this purpose.

The history of the English language provides an exemplary illustration of the idea of language species. The English language has primarily three roots—Anglo-Saxon English, Danish, and Norman French. In the history of England, Anglo-Saxon English and Danish merged in an egalitarian fashion. However, Norman French and old English merged in a hierarchical or dominant pattern. Law, i.e. the courts, and science use many words of Norman French origin, whereas agricultural and household activities are expressed in words of Anglo-Saxon or Danish origin.

To understand the utility of translating among language species, an exemplary embodiment of the present invention is drawn to translating scientific or technical writing into language that is more readily understandable by the general public.

The left column of Table 1 below shows an abstract from a scientific journal as it originally appeared in English with many words of Norman French origin. The right column of Table 1 shows a translated version of the abstract of the left column, as translated into English using words of Anglo-Saxon or Danish origin.

TABLE 1

| Original French/Latinate Phraseology | Anglo-Saxon/Danish Translation |
|---|---|
| Abstract | Overlook |
| Journalists, Cognition, and the | News Workers, How Folks Think, |
| Presentation of an Epidemiologic | and TV Shows about a Study of |
| Study: | Illness: |
| Cognitive processes can inform an | The way we think can shape our |
| understanding of newswork. In this | understanding of news work. In |
| case study, the authors examine a | this case study, the writers look at |
| growing literature relating cognitive | the growing body of thought link- |
| theories to newsmaking and then | ing the mind's workings to news |
| apply some of the principles in that | making and overlay their under- |
| literature to media coverage of EPA- | standing on the way news workers |
| mandated reformulated gasoline in | handle stories about the new |
| Milwaukee, Wisconsin. In an analysis | gasoline that EPA said must be |
| of how local Milwaukee television | used in Milwaukee, Wisconsin. In |
| news presented an epidemiologic | a look at how TV news in |
| study answering health complaints | Milwaukee broadcast a study about |
| associated with the gasoline additive, | illness answering grumbling about |
| the authors find a number of | health linked to the new gasoline, |
| cognitive processes at work, | the writers find many kinds of |
| especially those involving bias and | thinking going on, markedly those |
| error. Finally, the authors consider | with slanting and mistakes. Last, |
| implications of such processes for | the writers mull over the meaning |
| newsmaking. | of such forthcomings for news |
| | making. [“Translator's” notes: |
| | there are no modern Anglo words |
| | for “case study,” “stories,” and |
| | “gasoline” (i.e., chaotic air). |
| | Shortening “television” to TV is a |
| | typical folkway of Anglicizing a |
| | Latinate term.] |

The present invention may be used to translate English text having many words of Norman French origin into English text using primarily words of Anglo-Saxon or Danish origin. For example, with an English dictionary or thesaurus, the words of Norman French or Latin or Greek origin may be listed, for example, in the left column of a table, and corresponding alternative terms using only Anglo-Saxon or Danish rooted words may be listed, for example, in the right column. The present invention will then examine the English text and replace the words or phrases that appear in the left column with corresponding words or phrases that appear in the right column.

The present invention may additionally classify words by their level of difficulty, when there is more than one synonym. In this way, the program may translate any species of English text, not only into vernacular English (Anglo-Saxon/Danish) or international English (French/Latin), but also into a species of English text of greater or lesser difficulty.

The invention may additionally check for appropriate grammar (e.g., singular or plural words) and punctuation. When more than one phrase of one species is considered for translation, the present invention may either provide a plurality (or even all) possibilities for a reviewer to select. Further, the present invention may include a program or algorithm to select one of a plurality of acceptable phrases based either on the surrounding text or previous translations stored in computer memory.

An additional feature of the present invention includes a system and method for rating the “scientific” or “international” content of some text, for example by providing a ratio of Latin or Greek rooted words to all words in the text.

As discussed above, the present invention is different from conventional language translation programs. In particular, conventional translation programs translate from one language to another (e.g., from English to French), whereas the present invention is operable to translate from one species of a language to another species in the same language. The idea of translating between two species within a generic language is specific because the two sets of words are specified in some dictionaries. For example, the large versions of the American Heritage Dictionary of the English Language indicate the origin of words.

The present invention is different from readability improvement programs in that it goes beyond counting the number of letters in words or the number of words in a sentence. Instead, this invention is based on an understanding of the historical origins of languages and how that history affects the readability of text for different audiences. In particular, the present invention improves the readability of a particular text for a particular audience based on an associated species within a generic language understood by that particular audience.

The present invention may be used for language in fields such as science and technology, law and government, and biology and medicine.

In many modern languages, some words are more easily understood by the general public than other words. Words that are generally more easily understood by the general public are generally not of Latin or Greek origin, whereas words that are less easily understood by the general public generally are of Latin or Greek origin. Accordingly, to improve the readability of text for the general public, the present invention can remove words of Latin or Greek origin and substitute words not of Latin or Greek origin.

The present invention is not limited to the English language. Many languages have words of French, Latin or Greek origin. Science is usually conducted using these words. Indeed, in the days of Isaac Newton, scientists in many countries communicated with each other in Latin. Translating words of Latin origin into words of non-Latin origin improves the readability of scientific writing for the general public. For example, Table 2 below gives the title of the scientific article mentioned earlier. The left column uses Russian words of Latin origin. The right column uses Russian words of non-Latin origin. Native Russian speakers say the title in the right column is more vivid and would be more understandable for members of the general public of Russia. However, non-native Russian speakers may more readily understand the title in the left column because the words are recognized from their Latin origin.

TABLE 2

| Scientific | Colloquial |
|---|---|
| Paragraf | Obzor |
| Jurnalisti, Kognitziya i | Rabotniki novostey, sposob myshleniya |
| Presentatziya | televizionnye peredachi ob izucheniyi |
| epidemeologicheskogo ucheniya | bolezney |

The present invention is not limited to translating words of Latin origin into words of non-Latin origin. Indeed translating non-Latin rooted, words into Latin rooted words might improve the readability of text for a person from another country. In Table 2, the left column is easier for an English reader to understand, because the words have familiar roots. The right column may be more vivid and understandable to a native speaker of Russian, but the words in this column are less familiar to a non-native speaker of Russian.

Hence, the present invention provides a way to increase the readability of text to non-native speakers of a generic language without leaving the original language. Words in a generic language of Latin or Greek origin are more likely to be understood by non-native speakers of the generic language. To improve the readability of text to non-native speakers of a generic language, the present invention increases the number of international words in a body of text. “International words” may include English words in addition to Latin or Greek rooted words.

The present invention is not limited only to translation among species of a common generic language. The present invention exploits the fact that there are sub-languages within natural languages to translate from one natural language to another. For example, in accordance with the present invention, a body of text in General English (a combination of Anglo-Saxon/Danish and Norman French rooted words) can first be translated into a corresponding body of text in International English (Latin and Greek rooted words). Then the body of text in International English can then be translated into a corresponding body of text of International French (Latin and Greek rooted words). Finally the body of text of International French is translated into a corresponding body of text of vernacular French (words without Latin or Greek roots).

This is a new strategy for natural language translation. Most of the work in developing language translation programs has focused on identifying the context, and using the context to improve the quality of translation. The present invention makes use of sub-languages arising historically and existing within natural languages.

The present invention may include a computer that displays a second version of text beside the first version. Reading the same passage in different words may aid understanding, whether the reader is a non-technical person, a person less familiar with the language, etc.

The present invention can aid the public in understanding science by translating scientific articles into more accessible language. The present invention may additionally help scientists create scientific theories. For example, a social scientist could describe a social system in non-Latin rooted words and then translate the text into Latin-rooted words (the language of science). The resulting text may help scientists, particularly social scientists, understand how a scientific theory might be constructed of the situation described, by using more general, process-oriented words.

The present invention could aid in identifying plagiarism or disguising of text. By translating text from one version of a natural language to another version of the same natural language, the meaning remains the same, but the words used change dramatically. Hence, an act of plagiarism would be more difficult to detect by a casual reader. However, using the present invention to compare the same species of two texts could indicate whether an original text had been modified in order to hide plagiarism thereof.

A first exemplary embodiment of the present invention comprises a computer-implemented method of translating at least a portion of data of a first species of a generic language into data of a second species of the generic language. This computer-implemented method comprises receiving input data of a first species of a generic language, dividing the input data into a plurality of first data portions, accessing a memory having a data structure stored therein, the data structure comprising first species data portions, second species data portions corresponding to the first species data portions, respectively, and correspondence data portions indicating correspondence between the first species data portions and respective second species data portions, determining which of the plurality of first data portions are first species data portions, replacing one of the first data portions, that is one of the first species data portions, with a second species data portion that corresponds to the one of the first species data portions to obtain a modified plurality of data portions, combining the modified plurality of data portions as output data and outputting the output data.

One aspect of the first exemplary embodiment is drawn to the specifics of replacing the data portions. Specifically, the data structure further comprises correspondence data portions indicating correspondence between the first species data portions and the respective second species data portions. More specifically, replacing the first data portions comprises accessing a correspondence data portion to determine the corresponding second species data portion.

Another aspect of the first exemplary embodiment is drawn to the specifics of receiving the input data. Specifically, receiving input data may comprise receiving the input data from a keyboard, a voice data unit or a data file.

Another aspect of the first exemplary embodiment is drawn to the specifics of dividing the input data. Specifically, dividing the input data may comprise dividing the input data into a plurality of individual words or a plurality of individual phrases, wherein each of the phrases comprises a plurality of words.

Another aspect of the first exemplary embodiment is drawn to the specifics of accessing the memory. Specifically, accessing the memory may comprise accessing a look-up-table (LUT) in the memory, the LUT comprising a first species data section for storing the first species data portions as a plurality of first species data items, a second species data section for storing the second species data portions as a plurality of second species data items, and a correspondence section for storing the correspondence data portions as correspondence data items indicating correspondence between the first species data items and the second species data items. More particularly, accessing a LUT may comprise accessing a thesaurus.

The first exemplary embodiment may further comprise replacing all of the first data portions, that are of the first species data portions, with second species data portions that correspond to the first species data portions, respectively, to obtain the modified plurality of data portions.

Another aspect of the first exemplary embodiment is drawn to the specifics of outputting the output data. Specifically, outputting the output data may comprise outputting sound data for use with a speaker, outputting print data for use with a printer, outputting image data for use with a display device or outputting text data for use with a text data storage device.

A second exemplary embodiment of the present invention comprises a computer system comprising a processor and a memory coupled to the processor. In this computer system, the memory has stored therein a data structure comprising first species data portions, second species data portions corresponding to the first species data portions, respectively, correspondence data portions indicating correspondence between the first species data portions and respective second species data portions and processor readable instructions. The processor readable instructions enable the processor to receive input data of a first species of a generic language, divide the input data into a plurality of first data portions, access the memory, determine which of the plurality of first data portions are first species data portions, replace one of the first data portions, that is one of the first species data portions, with a second species data portion that corresponds to the one of the first species data portions to obtain a modified plurality data portions, combine the modified plurality of data portions as output data and output the output data.

One aspect of the second exemplary embodiment is drawn to the specifics of the processor being operable to replace one of the first data portions. Specifically, the data structure further comprises correspondence data portions indicating correspondence between the first species data portions and respective second species data portions. More particularly, the processor readable instructions that enable the processor to replace one of the first data portions comprise processor readable instructions that enable the processor to access a correspondence data portion to determine the corresponding second species data portion.

Another aspect of the second exemplary embodiment is drawn to the specifics of the processor being operable to receive input data. Specifically, the memory may include processor readable instructions that enable the processor to receive the input data from a keyboard, to receive voice data as the input data or to receive text data as the input data.

Another aspect of the second exemplary embodiment is drawn to the specifics of the processor being operable to divide the input data. Specifically, the memory may include processor readable instructions that enable the processor to divide the input data into a plurality of individual words or a plurality of individual phrases, wherein each of the phrases comprises a plurality of words.

Another aspect of the second exemplary embodiment is drawn to the specifics of the memory. Specifically, the memory may include a data structure comprising a LUT including a first species data section for storing the first species data portions as a plurality of first species data items, a second species data section for storing the second species data portions as a plurality of second species data items, and a correspondence section for storing the correspondence data portions as correspondence data items indicating correspondence between the first species data items and the second species data items. More particularly, the LUT may comprise a thesaurus.

The second exemplary embodiment may further comprise a processor readable instruction that enables the processor to replace all of the first data portions, that are of the first species data portions, with second species data portions that correspond to the first species data portions, respectively, to obtain the modified plurality of data portions.

Another aspect of the second exemplary embodiment is drawn to the specifics of the processor being operable to output the output data. Specifically, the memory may include processor readable instructions that enable the processor to output the output data as sound data for use with a speaker, to output the output data as print data for use with a printer, to output the output data as image data for use with a display device or to output the output data as text data for use with a text data storage device.

A third exemplary embodiment of the present invention comprises a computer system configured to translate a first species of a generic language into a second species of the generic language. In this third exemplary embodiment, the computer system comprises a memory having a data structure stored thereon, the data structure comprising first species data portions, second species data portions corresponding to the first species data portions, respectively, and correspondence data portions indicating correspondence between the first species data portions and respective second species data portions, an input unit operable to provide input data of a first species of a generic language, a processor operable to receive the input data from the input unit, to divide the input data into a plurality of first data portions, to access the memory, to determine which of the plurality of first data portions are first species data portions, to replace one of the first data portions, that is one of the first species data portions, with a second species data portion that corresponds to the one of the first species data portions to obtain a modified plurality data portions, and to combine the modified plurality of data portions as output data and an output unit operable to output the output data.

One aspect of the third exemplary embodiment of the present invention is drawn to the specifics of the processor being operable to replace one of the first data portions. In particular, the data structure further comprises correspondence data portions indicating a correspondence between the first species data portions and respective second species data portions. More particularly, the processor is operable to replace one of the first data portions by accessing a correspondence data portion to determine the corresponding second species data portion.

Another aspect of the third exemplary embodiment of the present invention is drawn to the specifics of the input unit. Specifically, the input unit may comprise a keyboard, a voice data delivery unit or a text data delivery unit.

Another aspect of the third exemplary embodiment of the present invention is drawn to the processor being operable to divide the input data. Specifically, the processor may be operable to divide the input data into a plurality of individual words or a plurality of individual phrases, wherein each of the phrases comprises a plurality of words into a plurality of individual words or a plurality of individual phrases, wherein each of the phrases comprising a plurality of words.

Another aspect of the third exemplary embodiment of the present invention is drawn to the specifics of the memory. Specifically, the data structure may comprise a LUT comprising a first species data section for storing the first species data portions as a plurality of first species data items, a second species data section for storing the second species data portions as a plurality of second species data items, and a correspondence section for storing the correspondence data portions as a plurality of correspondence data items indicating correspondence between the first species data items and the second species data items. More particularly, the LUT may comprise a thesaurus.

The third exemplary embodiment may further comprise a processor being operable to replace all of the first data portions, that are of the first species data portions, with second species data portions that correspond to the first species data portions, respectively, to obtain the modified plurality of data portions.

Another aspect of the third exemplary embodiment of the present invention is drawn the specifics of the output unit. In particular, the output unit may comprise a speaker, a printer, a display device or a text storage device.

A fourth exemplary embodiment of the present invention comprises a computer-readable medium having stored thereon a data structure comprising first species data portions, second species data portions corresponding to the first species data portions, respectively, correspondence data portions indicating correspondence between the first species data portions and respective second species data portions and computer readable instructions. The computer readable instructions of the fourth exemplary embodiment enable a computer to receive input data of a first species of a generic language, divide the input data into a plurality of first data portions, access the data structure, determine which of the plurality of first data portions are first species data portions, replace one of the first data portions, that is one of the first species data portions, with a second species data portion that corresponds to the one of the first species data portions, to obtain a modified plurality data portions, combine the modified plurality of data portions as output data and output the output data.

One aspect of the fourth exemplary embodiment of the present invention is drawn to the specifics of enabling the computer to replace one of the first data portions. In particular, the data structure further comprises correspondence data portions indicating correspondence between the first species data portions and respective second species data portions. More particularly, the computer readable instructions that enable the computer to replace one of the first data portions comprises computer readable instructions that enable the computer to access a correspondence data portion to determine the corresponding second species data portion.

Another aspect of the fourth exemplary embodiment of the present invention is drawn to the specifics of enabling the computer to receive the input data. Specifically, the computer readable instructions include computer readable instructions that enable the processor to receive the input data from a keyboard, to receive voice data as the input data or to receive text data as the input data.

Another aspect of the fourth exemplary embodiment of the present invention is drawn to the specifics of enabling the computer to divide the input data. Specifically, the computer readable instructions include computer readable instructions that enable the processor to divide the input data into a plurality of individual words or a plurality of individual phrases, wherein each of the phrases comprising a plurality of words.

Another aspect of the fourth exemplary embodiment of the present invention is drawn to the specifics of the data structure. Specifically, data structure includes a LUT including a first species data section for storing the first species data portions as a plurality of first species data items, a second species data section for storing the second species data portions as a plurality of second species data items, and a correspondence section for storing the correspondence data portions as a plurality of correspondence data items indicating correspondence between the first species data items and the second species data items. More particularly, the LUT may comprise a thesaurus.

The fourth exemplary embodiment of the present invention may further comprise a computer readable instruction that enables the computer to replace all of the first data portions, that are of the first species data portions, with second species data portions that correspond to the first species data portions, respectively, to obtain the modified plurality of data portions.

Another aspect of the fourth exemplary embodiment of the present invention is drawn to the specifics of enabling the computer to output the output data. Specifically, the computer readable instructions may include computer readable instructions that enable the computer to output the output data as sound data for use with a speaker, to output the output data as print data for use with a printer, to output the output data as image data for use with a display device or to output the output data as text data for use with a text data storage device.

A fifth exemplary embodiment of the present invention comprises a method of translating data of a first species of a first generic language into data of a first species of a second generic language. The fifth embodiment comprises translating data of a first species of a first generic language into data of a second species of the first generic language, translating the data of the second species of the first generic language into data of a second species of a second generic language and translating the data of the second species of the second generic language into data of a first species of the second generic language.

Additional objects, advantages and novel features of the invention are set forth in part in the description which follows, and in part which will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and form part of the specification, illustrate exemplary embodiments of the present invention and, together with the description, serve to explain the principles of the invention. In the drawings:

FIG. 1 is a block diagram of a system that may be programmed to implement the present invention;

FIG. 2 illustrates translation of a technical species of a generic language to the vernacular species of a generic language;

FIG. 3 illustrates the translation of one species of a generic language to another species of a second generic language;

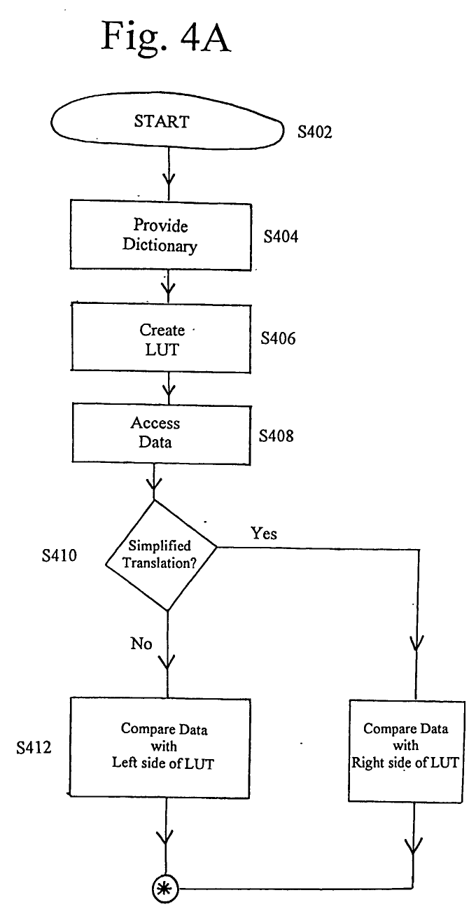

FIGS. 4A and 4B are a logical flow chart illustrating a method for translating between two species of a generic language in accordance with one embodiment of the present invention; and

FIG. 5 is a logical flow chart illustrating a method of translating between two generic languages in accordance with a second embodiment of the present invention.

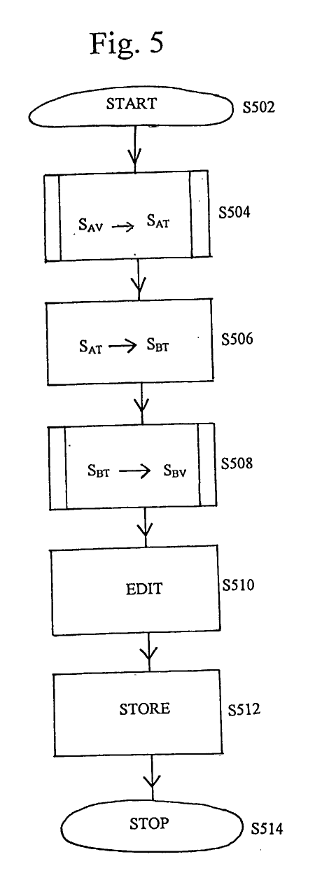

### DETAILED DESCRIPTION OF THE INVENTION

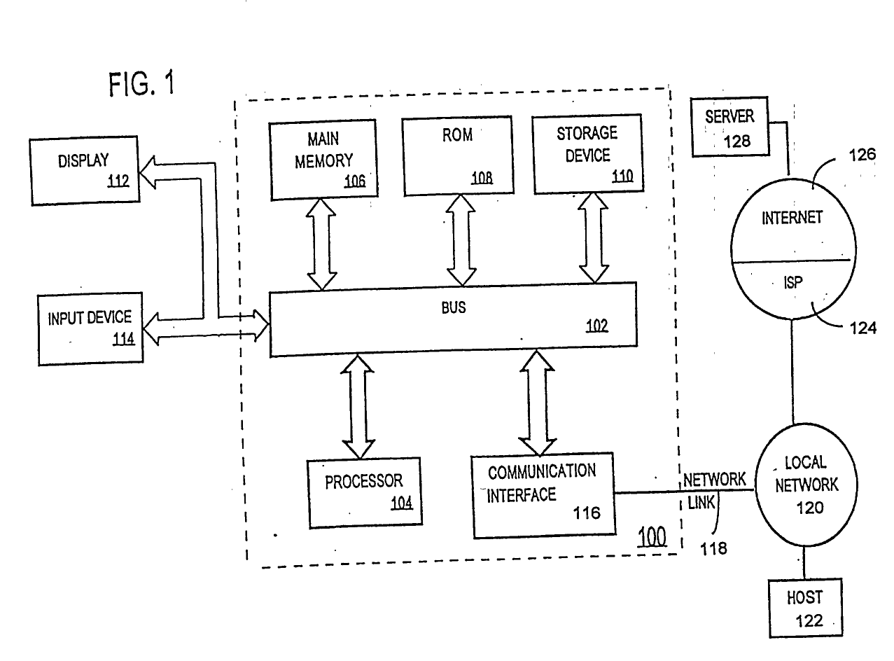

FIG. 1 is a block diagram that illustrates an exemplary computer system 100 upon which an embodiment of the invention may be implemented. Computer system 100 includes a bus 102 or other communication mechanism for communicating data, and a processor 104 coupled with bus 102 for processing data. Computer system 100 also includes a main memory 106, such as a random access memory (RAM) or other dynamic storage device, coupled to bus 102 for storing data and instructions to be executed by processor 104. Main memory 106 also may be used for storing temporary variables or other intermediate data during execution of instructions to be executed by processor 104. Computer system 100 further includes a read only memory (ROM) 108 or other static storage device coupled to bus 102 for storing static data and instructions for processor 104. A storage device 110, such as a magnetic disk or optical disk, is provided and coupled to bus 102 for storing data and instructions. Furthermore, processor 104 may additionally include a memory therein, e.g. a cache, for storing data and instructions to be executed by processor 104.

Computer system 100 may be coupled via bus 102 to a display 112, such as for example a cathode ray tube (CRT) or liquid crystal display (LCD), for displaying data to a user. An input device 114 is coupled to bus 102 for communicating data and command selections to processor 104. Non-limiting examples of an input device include a keyboard, mouse, trackball, joystick, lightpen, OCRs (Optical Character Recognition systems), voice-activation system, or the like.

The invention is related to the use of computer system 100 for translating one language to another language. According to one embodiment of the invention, a translation of one species of a generic language into another species of the generic language is produced by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CDROM, any other optical medium, punch cards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 116 coupled to bus 102. Communication interface 116 provides a two-way data communication coupling to a network link 118 that is connected to a local network 120. For example, communication interface 116 may be an integrated services digital network (ISDN) card or a modem to provide a data communication connection to a corresponding type of telephone line. As another example, communication interface 116 may be a local area network (LAN) card to provide a data communication connection to a compatible LAN. Wireless links may also be implemented. In any such implementation, communication interface 116 sends and receives electrical, electromagnetic or optical signals that carry digital data streams representing various types of data.

Network link 118 typically provides data communication through one or more networks to other data devices. For example, network link 118 may provide a connection through local network 120 to a host computer 122 or to data equipment operated by an Internet Service Provider (ISP) 124. ISP 124 in turn provides data communication services through the world wide packet data communication network now commonly referred to as the “Internet” 126. Local network 120 and Internet 126 both use electrical, electromagnetic or optical signals that carry digital data streams. The signals through the various networks and the signals on network link 118 and through communication interface 116, which carry the digital data to and from computer system 100, are exemplary forms of carrier waves transporting the data.

Computer system 100 can send messages and receive data, including program code, through the network(s), network link 118 and communication interface 116. In the Internet example, a server 128 might transmit a requested code for an application program through Internet 126, ISP 124, local network 120 and communication interface 116. In accordance with the invention, one such downloaded application provides for translating from one species to another species as described herein.

The received code may be executed by processor 104 as it is received, and/or stored in storage device 110, or other non-volatile storage for later execution. In this manner, computer system 100 may obtain application code in the form of a carrier wave.

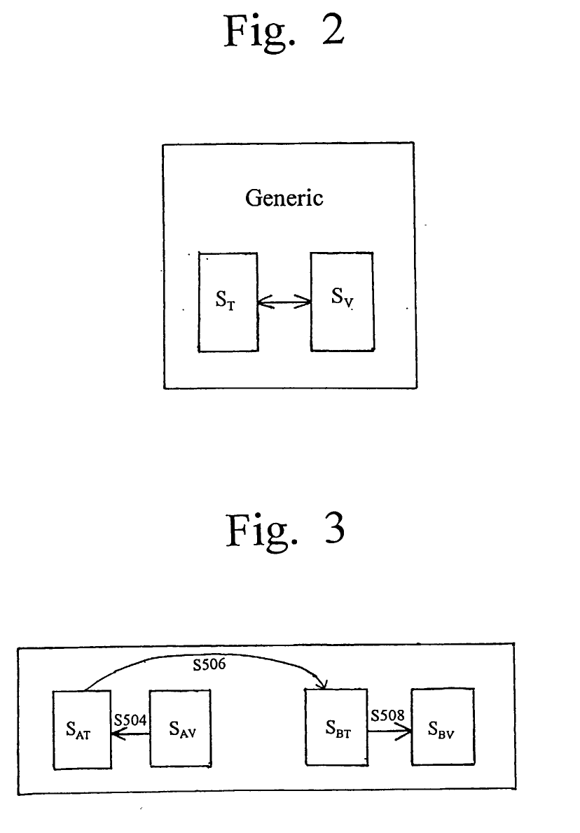

The operation of an exemplary embodiment of the present invention will now be described with reference to FIGS. 1, 2, 4A and 4B. In particular, the following exemplary embodiment includes the computer system 100 of FIG. 1 operating so as to translate data of one species of a generic language, for example a technical species S_{T}, into data of a second species of the generic language, for example a vernacular species S_{V}, or vice versa. In the following exemplary embodiment, because the translation is accomplished via a computer system, there are further inherent translations which are not described in detail herein. In particular, although the data is a body of written text, the written text is first translated into computer readable code wherein the computer readable coded text is translated into a second computer readable coded text that corresponds to the second species. Further the second computer readable coded text is then translated into a user readable text that corresponds to the second species. In the exemplary embodiment described immediately below, computer system 100 includes a graphical user interface (GUI) to enable a user to efficiently interface therewith, without being fluent in the computer readable code.

At the start of the translating process (S402) a dictionary is provided (S404). The dictionary may be entered manually via input device 114. However, more preferably, the dictionary is provided via software that has been loaded into storage device 114 or software that has been accessed from server 128 or host 122 via network link 118. The dictionary itself may be stored in any one of main memory 106 storage device 110 or even a cache memory provided in processor 104.

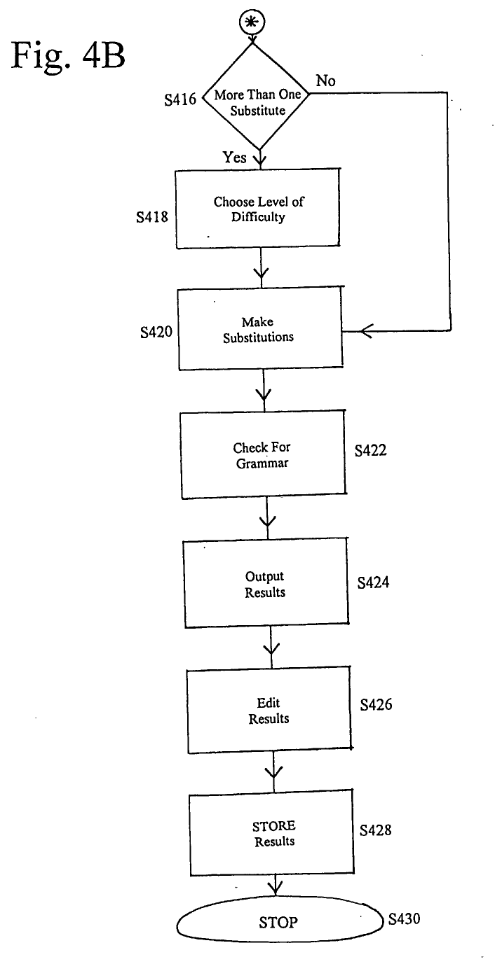

Returning to FIG. 4A, after a dictionary has been provided (S404), a data structure for arranging data items in the dictionary is created (S406). In this exemplary embodiment, the data structure is a LUT. More specifically, in this exemplary embodiment the LUT may comprise a first column having a list of data items wherein each item in the list is an English word or phrase of Latin origin. The LUT further may comprise a second column having a plurality of data items wherein each data item is an English word or phrase of non-Latin origin. The LUT may be arranged such that each data item in the first column corresponds to a data item in the second column. Accordingly, access to a data item in one column would easily enable translation via accessing the corresponding data item in the other column. Furthermore, a data item in one column may correspond to a plurality of data items in the other column, for example in the case of listing synonyms.

Furthermore, the LUT may be arranged such that the arrangement of the data items in the first column does not affect the arrangement of the data items in the second column. Accordingly, any changes to the first or second column need not affect the other column. However, if the LUT is arranged in such a manner, the LUT may further comprise a third column having correspondence data items wherein each correspondence data item acts as a pointer for pointing corresponding data items of one column to the other column. This exemplary embodiment of the present invention includes such a correspondence data column. In particular, the correspondence data column is used to map an array, or plurality, of choices for translating one word or phrase in one column to another word or phrase in the other column.

Returning to FIG. 4A, once the LUT has been created (S406), the data to be translated is accessed (S408). In this exemplary embodiment, the accessed data is the text as illustrated in the left column of Table 1. This accessed text may be retrieved from main memory 106, storage device 110, a cash in the processor 104 or an external memory that is accessed via network link 118. Further, this accessed text may be inputted into any one of these storage devices by way of input device 114.

It may then be determined whether the accessed text is to be translated into a more simplified text or a more complicated text (S410). In this exemplary embodiment, the GUI enabled display 112 prompts the user to answer a question, for example, “Translate into simplified text?”.

If it is determined that the text is to be translated into a simplified text, or a simplified species of the language, then the accessed text is compared with the first column of the LUT (S414). In particular, it is determined which words or phrases in the first column of the LUT are present in the accessed text. Once words or phrases from the first column of the LUT are identified and located in the accessed text, the corresponding words or phrases in the second column of the LUT are identified via the correspondence data items.

However, this exemplary embodiment additionally enables the user to choose one of a plurality of viable options for many translation word or phrases. In particular, it is first determined whether for each word or phrase, which is to be translated, there is more than one corresponding word or phrase in the second column of the LUT (S416). If it is determined that there is more than one corresponding word or phrase in the second column of the LUT, then the user is able to choose which word or phrase is to be used as a substitute (S418). In this exemplary embodiment, computer readable instructions are provided to enable the processor to determine which substitute should be used. In particular, the GFI prompts the user via display 112 to choose a level of difficulty of the translation. In particular, the GFI may prompt the user with a question, such as, “Is this a technical or a very technical translation?” Once the level of difficulty is chosen, the computer readable instructions enable the processor to determine which word or phrase is to be used based on a pre-determined ranking of each option.

In the variation of the present invention, the GFI may prompt the user via display 112 which word or phrase in the second column of the LUT to use. In particular, the GFI may list all the options and permit the user to choose which option.

At this point, every word or phrase from the first column of the LUT that is located in the accessed text is replaced with a corresponding word or phrase in the second column of the LUT (S420).

On the other hand, if it is determined that the text is to be translated into a more complicated text, or a complicated species of the language, then the data of the access text is compared with the second column of the LUT (S412). In particular, it is determined which words or phrases in the second column of the LUT are present in the accessed text. Once words or phrases from the second column of the LUT are identified and located in the accessed text, the corresponding words or phrases in the first column of the LUT are identified via the correspondence data items.

Again, it is determined whether, for each word or phrase which is to be translated, there is more than one corresponding word or phrase in the first column of the LUT (S416). If it is determined that there is more than one corresponding word or phrase in the first column of the LUT, the user is able to choose which word or phrase is to be used as a substitute (S418).

At this point, every word or phrase from the second column of the LUT that is located in the accessed text is replaced with a corresponding word or phrase in the first column of the LUT (S420).

At this point, the accessed text has been translated from a technical species of a generic language S_{T} into text of a vernacular species of the generic language S_{V} (or, alternatively, for example from a vernacular species of the generic language S_{V} to a technical species of the generic language S_{T}). In this exemplary embodiment, however, grammar and contextual meaning are additionally checked (S422) to ensure proper readability. For example, conventional grammar checking programs may be used that include programs that check (and correct) for contextual meaning. In particular, a conventional grammar checking program may be implemented that determines the correct translation based on the frame of cultural existence within the text (for example, the word “take” may have many meanings, e.g. take a position during war meaning kill the adversaries, take a girlfriend to dinner meaning accompany, etc.). The results of the translation are then output (S424). For example, the results may be displayed on display 112, printed on a printer and/or stored in any one of main memory 106, storage device 110, a cache located in processor 104 or an external storage device via network link 118.

The exemplary embodiment additionally enables the user to edit the results (S426) for example via input device 114. The edited results may then be stored (S428), for example in main memory 106, in storage device 110, in a cache located in the processor 104 or in an external storage via network link 118. The process then stops (S430).

The above-described process is merely an exemplary embodiment, wherein other variations may be used with the inventive concept thereof

A second exemplary embodiment will now be described below with reference to FIGS. 1,3 and 5. In particular, this second exemplary embodiment includes computer system 100 operating so as to translate a body of text from one species of one generic language, for example a vernacular species of a first generic language S_{AV}, to a body of text in one species of a second generic language, for example a vernacular species of a second generic language S_{BV}.

The process is first initiated (S502), for example, on computer system 100. The body of text is then translated from one species of the generic language to a second species of the generic language (S504). The translation process from one species to another species is the same process as described for example with respect to FIGS. 4A and 4B. In particular, in this exemplary embodiment, the accessed text is a vernacular species of a first generic language S_{AV} and the accessed text is translated into text of a technical species of the first generic language S_{AT}.

The text of the technical species of the first generic language S_{AT} is then translated into text of a technical species of a second generic language S_{BT} (S506). A conventional language translating program may be used for this step in the process. For example, a conventional English-to-French translating program may be used.

The text of the technical species of the second generic language S_{BT} is then translated into text of a vernacular species of the second generic language S_{BV} (S508). Again this translating process is the same as described with respect to FIGS. 4A and 4B. In particular, the accessed data of S408 at this point is the text of the technical species of the second generic language S_{BT}.

The text of the vernacular species of the second generic language S_{BV} may be edited by the user (S510). Finally, the edited text is stored (S512) and the process stops (S514).

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments as described above were chosen and described in order to best explain the principles of the invention and its practical application to thereby enable others skilled in the arts to best utilize the invention in various embodiments and with various modifications as are suited to the particular use contemplated. It is intended that the scope of the invention be defined by the claims appended hereto.

What is claimed is:

1. A computer-implemented method of translating at least a portion of data of a first species of a generic language into data of a second species of the generic language, said computer-implemented method comprising:
receiving input data of a first species of a generic language;
dividing the input data into a plurality of first data portions;
accessing a memory having a data structure stored therein, the data structure comprising first species data portions and second species data portions corresponding to the first species data portions, respectively
determining which of the plurality of first data portions are first species data portions;
replacing one of the first data portions, that is one of the first species data portions, with a second species data portion that corresponds to the one of the first species data portions to obtain a modified plurality of data portions;
combining the modified plurality of data portions as output data; and
outputting the output data.

2. The computer-implemented method of claim 1, wherein the data structure further comprises correspondence data portions indicating correspondence between the first species data portions and respective second species data portions, and
wherein said replacing the one of the first data portions comprises accessing a correspondence data portion to determine the corresponding second species data portion.

3. The computer-implemented method of claim 1, wherein said dividing the input data comprises dividing the input data into a plurality of individual words.

4. The computer-implemented method of claim 1, wherein said dividing the input data comprises dividing the input data into a plurality of individual phrases, each of the phrases comprising a plurality of words.

5. The computer-implemented method of claim 1, wherein said accessing the memory comprises accessing a lookup table in the memory, the lookup table comprising a first species data section for storing the first species data portions as a plurality of first species data items, a second species data section for storing the second species data portions as a plurality of second species data items, and a correspondence section for storing correspondence data portions as correspondence data items indicating correspondence between the first species data items and the second species data items.

6. The computer-implemented method of claim 1, further comprising replacing all of the first data portions, that are of the first species data portions, with second species data portions that correspond to the first species data portions, respectively, to obtain the modified plurality of data portions.

7. A computer system configured to translate a first species of a generic language into a second species of the generic language, said computer system comprising:
a processor; and
a memory coupled to said processor, said memory having stored therein a data structure comprising first species data portions, second species data portions corresponding to the first species data portions, respectively, and processor readable instructions that enable said processor to,
receive input data of a first species of a generic language,
divide the input data into a plurality of first data portions,
access said memory,
determine which of the plurality of first data portions are first species data portions,
replace one of the first data portions, that is one of the first species data portions, with a second species data portion that corresponds to the one of the first species data portions to obtain a modified plurality of data portions,
combine the modified plurality of data portions as output data, and
output the output data.

8. The computer system of claim 7, wherein the data structure further comprises correspondence data portions indicating correspondence between the first species data portions and respective second species data portions, and
wherein the processor readable instructions that enable said processor to replace the one of the first data portions comprises processor readable instructions that enable the processor to access a correspondence data portion to determine the corresponding second species data portion.

9. The computer system of claim 7, wherein said memory includes a processor readable instruction that enables said processor to divide the input data into a plurality of individual words.

10. The computer system of claim 7, wherein said memory includes a processor readable instruction that enables said processor to divide the input data into a plurality of individual phrases, each of the phrases comprising a plurality of words.

11. The computer system of claim 7, wherein the data structure comprises a lookup table including a first species data section for storing the first species data portions as a plurality of first species data items, a second species data section for storing the second species data portions as a plurality of second species data items, and a correspondence section for storing correspondence data portions as correspondence data items indicating correspondence between the first species data items and the second species data items.

12. The computer system of claim 7, wherein said memory includes a processor readable instruction that enables said processor to replace all of the first data portions, that are of the first species data portions, with second species data portions that correspond to the first species data portions, respectively, to obtain the modified plurality of data portions.

13. A computer system comprising:
a memory having a data structure stored therein, the data structure comprising first species data portions and second species data portions corresponding to the first species data portions, respectively,
an input unit operable to provide input data of a first species of a generic language;
a processor operable to receive the input data from said input unit, to divide the input data into a plurality of first data portions, to access said memory, to determine which of the plurality of first data portions are first species data portions, to replace one of the first data portions, that is one of the first species data portions, with a second species data portion that corresponds to the one of the first species data portions to obtain a modified plurality of data portions, and to combine the modified plurality of data portions as output data; and
an output unit operable to output the output data.

14. The computer system of claim 13, wherein the data structure further comprises correspondence data portions indicating correspondence between the first species data portions and respective second species data portions, and
wherein said processor is operable to replace the one of the first data portions by accessing a correspondence data portion to determine the corresponding second species data portion.

15. The computer system of claim 13, wherein said processor is operable to divide the input data into a plurality of individual words.

16. The computer system of claim 13, wherein said processor is operable to divide the input data into a plurality of individual phrases, each of the phrases comprising a plurality of words.

17. The computer system of claim 13, wherein the data structure comprises a lookup table comprising a first species data section for storing the first species data portions as a plurality of first species data items, a second species data section for storing the second species data portions as a plurality of second species data items, and a correspondence section for storing correspondence data portions as a plurality of correspondence data items indicating correspondence between the first species data items and the second species data items.

18. The computer system of claim 13, wherein said processor is operable to replace all of the first data portions, that are of the first species data portions, with second species data portions that correspond to the first species data portions, respectively, to obtain the modified plurality of data portions.

19. A computer-readable medium having stored thereon a data structure comprising first species data portions, second species data portions corresponding to the first species data portions, respectively, and computer readable instructions that enable the computer to:
receive input data of a first species of a generic language;
divide the input data into a plurality of first data portions;
access the data structure;
determine which of the plurality of first data portions are first species data portions;
replace one of the first data portions, that is one of the first species data portions, with a second species data portion that corresponds to the one of the first species data portions, to obtain a modified plurality data portions;
combine the modified plurality of data portions as output data; and
output the output data.

20. The computer-readable medium of claim 19, wherein the data structure further comprises correspondence data portions indicating correspondence between the first species data portions and respective second species data portions, and
wherein the computer readable instructions that enable the computer to replace the one of the first data portions comprises computer readable instructions that enable the computer to access a correspondence data portion to determine the corresponding second species data portion.

21. The computer-readable medium of claim 19, wherein the computer readable instructions include a computer readable instruction that enables the processor to divide the input data into a plurality of individual words.

22. The computer-readable medium of claim 19, wherein the computer readable instructions include a computer readable instruction that enables the processor to divide the input data into a plurality of individual phrases, each of the phrases comprising a plurality of words.

23. The computer-readable medium of claim 19, wherein the data structure comprises a lookup table including a first species data section for storing the first species data portions as a plurality of first species data items, a second species data section for storing the second species data portions as a plurality of second species data items, and a correspondence section for storing correspondence data portions as a plurality of correspondence data items indicating correspondence between the first species data items and the second species data items.

24. The computer-readable medium of claim 19, wherein the computer readable instructions include a computer readable instruction that enables the processor to replace all of the first data portions, that are of the first species data portions, with second species data portions that correspond to the first species data portions, respectively, to obtain the modified plurality of data portions.

25. A method of translating data of a first species of a first generic language into data of a first species of a second generic language, said method comprising:
translating data of a first species of a first generic language into data of a second species of the first generic language;
translating the data of the second species of the first generic language into data of a second species of a second generic language; and
translating the data of the second species of the second generic language into data of a first species of the second generic language.
